(19) United States
(12) Patent Application Publication
(10) Pub. No.: US 2010/0144973 A1
(43) Pub. Date: Jun. 10, 2010

(54) Particulate Rubber Composition

(76) Inventors: Pin-Tsung CHENG, Kaohsiung City (TW); Li-Hsiang LIN, Kaohsiung County (TW)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/472,527

(22) Filed: May 27, 2009

(30) Foreign Application Priority Data
Dec. 4, 2008 (TW) 097147132

(51) Int. Cl. C08L 19/00; C08G 79/00; C08L 83/00; C08F 36/08

(52) U.S. Cl. 525/232; 525/55; 525/389; 525/474; 526/335

(57) ABSTRACT

A particulate rubber composition includes a plurality of rubber particles. At least some of the rubber particles have tensile fractured surfaces. The particulate rubber composition is produced by a method that includes disintegrating a cross-linked rubber product to form the rubber particles using a high-speed jets fluid to impinge the cross-linked rubber product. The high-speed jets fluid has a Reynold's number that ranges from 100,000 to 4,000,000. A product including a polymeric matrix material and the particulate rubber composition is also disclosed.

### BACKGROUND OF THE INVENTION

1. Field of the Invention

This invention relates to a rubber composition, more particularly to a particulate rubber composition.

2. Description of the Related Art

Natural rubber or synthetic rubber can be cross-linked by virtue of sulfur (i.e., vulcanization) or peroxides in order to produce a conventional rubber product such as a tire, a shoe sole, a rubber tube, or a rubber sheet. The rubber product that is discarded is regarded as a waste rubber product. Generally, the waste rubber product may not be transformed into a recycled product that has a good chemical property or a good mechanical property by virtue of simply heating or processing the waste rubber product. Therefore, in early days, mechanical treatment is used for disintegrating the waste rubber product into sheets, granules, or powder. The recycled rubber can be used directly in a landfill, as an additive in asphalt for road pavement, or to be compounded for making low-quality goods (e.g., a rubber mat and a splashboard). During the mechanical disintegration of the waste rubber product, a reamer may give rise to heat transfer and overheating. Some portions of the cross-linked waste rubber product are consequently subject to coking due to heat induced by the reamer. As a result, the recycled rubber particles made from the waste rubber product have irregular surfaces with a great amount of coke clusters existing thereon.

In recent years, the waste rubber products have been recycled and converted into a more valuable material called reclaimed rubber that is suitable for wide applications. The waste rubber products are processed through physical and chemical processes such as disintegration, heating, depolymerization, and mechanical treatment in order to produce the reclaimed rubber that has plasticity and re-vulcanizable properties. Methods of reclaiming the waste rubber products include a direct steaming process (such as a static oil process or a dynamic oil process), steaming and boiling processes (such as a digester method process, an alkaline process, and a neutralization process), a mechanical process (such as a rapid stirring process, a process including operating a Banbury mixer, or a screw extruding process), a chemical process (such as using a solvent to soak and swell the waste rubber product which is therefore formed into liquid or semi-liquid reclaimed rubber at a high temperature, or adding an unsaturated acid to the waste rubber product to produce carboxyl-group containing reclaimed rubber at a high temperature), a physical process (such as a microwave process, a far-infrared process, or an ultrasonic process), etc. Among others, the oil process and the water-oil process are normally used, and require heat, a reclaiming agent (such as a softener, an activator, or a tackifier), and oxygen. Desulfurization is mainly designed for breaking the cross-linked network of the waste rubber product such that the waste rubber product is broken into a group which includes small and insoluble cross-linked fragments, and another group which includes soluble straight chain or branched chain fragments.

The reclaimed rubber can be used as an additive or for producing low-quality goods. As a filler for a shoe making material, the weight of the reclaimed rubber can be at most 10% of the weight of the shoe making material in order to confer the shoe making material a satisfactory physical property. For a non-high quality product, about 100 or more parts by weight of the reclaimed rubber powder that has a size of 40 mesh can be added. In the case of an average quality product (such as the tire), only about 10 to 20 parts by weight of the reclaimed rubber powder that has a size smaller than 100 mesh can be added. The smaller the size of the reclaimed rubber powder is, the more the reclaimed rubber powder can be added.

However, the reclaimed rubber is formed by means of complex processes and chemical reagents, and is still unable to completely replace the natural rubber, synthetic rubber, or other plastic materials. Further improvement is necessary to increase applications of the reclaimed rubber.

Since an amount of the waste rubber products is increasing, there is a need to provide a rubber material that is recycled from the waste rubber product through a simple method which does not utilize chemical reagents harmful to the environment, that is environmentally friendly like natural rubber, and that can be substituted for thermoplastic polymers or thermoplastic rubber.

### SUMMARY OF THE INVENTION

The object of the present invention is to provide a particulate rubber composition that can be produced from waste rubber through an environmentally friendly method.

According to one aspect of this invention, a particulate rubber composition includes a plurality of rubber particles. At least some of the rubber particles have tensile fractured surfaces. The particulate rubber composition is produced by a method that includes disintegrating a cross-linked rubber product to form the rubber particles using a high-speed jets fluid to impinge the cross-linked rubber product.

According to another aspect of this invention, an article includes a polymeric matrix material and the particulate rubber composition as mentioned in the first aspect of this invention, which includes a plurality of the rubber particles incorporated into the polymeric matrix material.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a schematic view to illustrate a high-speed jets fluid device that is used for making the preferred embodiment of a particulate rubber composition according to the present invention;

FIG. 2 is a fragmentary perspective view to illustrate a jet unit of the device shown in FIG. 1;

FIG. 3 shows scanning electron microscope (SEM) photomicrographs at 100× magnification to illustrate rubber particles of examples 1 and 2;

FIG. 4 shows SEM photomicrographs at 100× magnification to illustrate the rubber particles of example 3 and comparative example 1;

FIG. 5 shows SEM photomicrographs at 300× magnification to illustrate the rubber particles of examples 1 and 2;

FIG. 6 shows SEM photomicrographs at 300× magnification to illustrate the rubber particles of example 3 and comparative example 1;

FIG. 7 shows Raman spectra for the rubber particles of example 2 and comparative example 1;

FIG. 8 shows a Raman spectrum of comparative example 2;

FIG. 9 shows Raman spectra for examples 1-3 and comparative example 3;

FIG. 10 shows small angle X-ray scattering spectra for examples 1-3, and comparative examples 2 and 3;

FIG. 11 shows wide angle X-ray diffraction spectra of examples 1-3, and comparative examples 2 and 3;

FIG. 12 shows X-ray absorption spectra of examples 1-3 and comparative examples 2-3; and

FIG. 13 is a schematic diagram to illustrate a speculative reaction mechanism that converts a cross-linked rubber product into the particulate rubber composition of the present invention.

### DETAILED DESCRIPTION OF THE PREFERRED EMBODIMENTS

The particulate rubber composition according to the present invention includes a plurality of rubber particles. At least some of the rubber particles have tensile fractured surfaces. Coke clusters are hardly observed on the rubber particles.

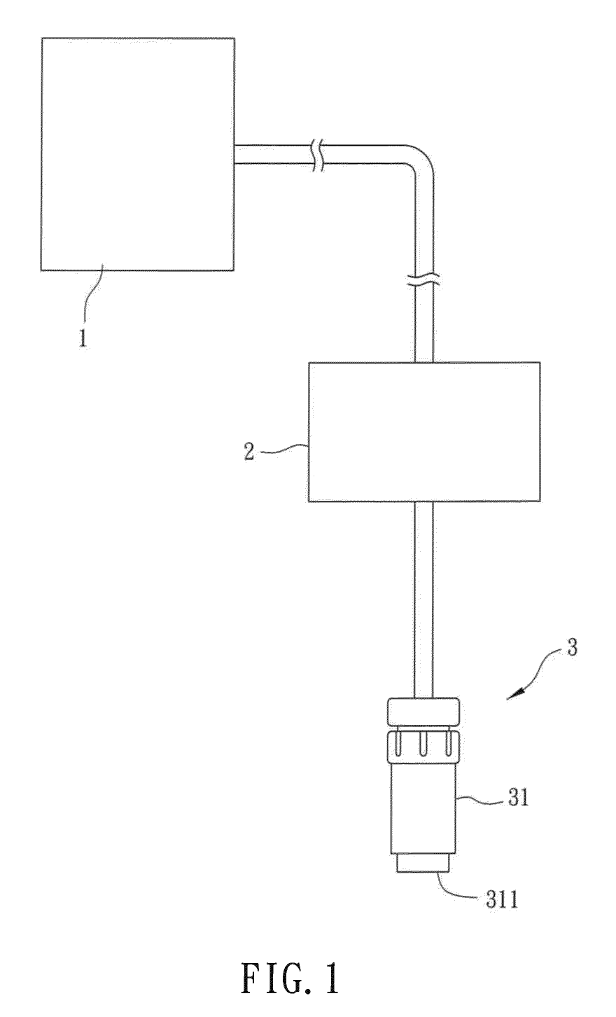

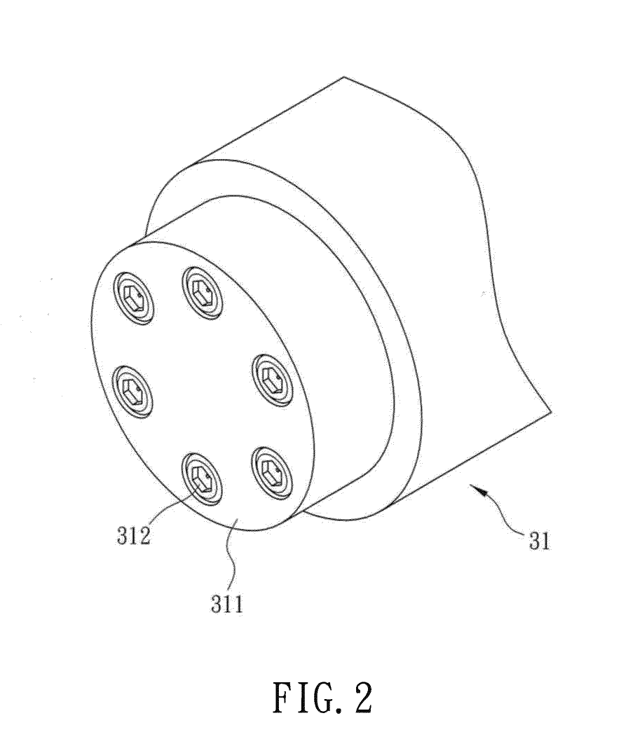

A method of making the particulate rubber composition includes disintegrating a cross-linked rubber product into the rubber particles using a high-speed jets fluid to impinge the cross-linked rubber product. Referring to FIGS. 1 and 2, the high-speed jets fluid is produced by a high-speed jets fluid device that includes a fluid container 1, a pressure-increasing and temperature-controlling unit 2, and a jet unit 3. The fluid container 1 is connected to the pressure-increasing and temperature-controlling unit 2, and is adapted to contain a fluid. The jet unit 3 is connected to the pressure-increasing and temperature-controlling unit 2, and includes a jet member 31 that has a round surface 311 and a plurality of nozzles 312. The high-speed jets fluid is ejected through the nozzles 312 which are disposed circumferentially in the round surface 311 and which are rotatable and adjustable in ejection angles. Optionally, the pressure-increasing and temperature-controlling unit 2 can be controlled to intermittently produce an output power and to rotate the nozzles 312 so that the high-speed jets fluid is converted into a rotating pulse jet two-phase fluid. Furthermore, a solid medium and/or a liquid medium other than the jet fluid may be added optionally to the jet fluid in the fluid container 1 or into a recycling container containing the cross-linked rubber product in order to enhance the impinging effect on the cross-linked rubber product.

The Reynold's number for the high-speed jets fluid can be determined using the following equation:

$$Re = \frac{D \times {U}_{m}}{v}$$

where Re is the Reynold's number, D is the diameter (m) of the nozzle, Uₘ is the initial fluid velocity (m/sec), and ν is kinematic viscosity (m²/sec) of the fluid, ν=μ/ρ, where μ is static viscosity of the fluid, and ρ is the density of the fluid. Preferably, the Reynold's number for the high-speed jets fluid ranges from 100,000 to 4,000,000.

The high-speed jets fluid has the initial velocity that ranges from 560 to 1150 m/sec, and initial kinetic energy (based on a single nozzle) that ranges from 10×10³ to 995×10³ KJ. Preferably, the high-speed jets fluid has the initial velocity that ranges from 620 to 750 m/sec, and the initial kinetic energy (based on a single nozzle) that ranges from 22×10³ to 400×10³ KJ.

When the cross-linked rubber product is impinged by the high-speed jets fluid, a temperature of an impinged area ranges from 40° C. to 95° C. Preferably, the temperature of the impinged area ranges from 45° C. to 90° C.

An example of the cross-linked rubber product is a vulcanized rubber product. The cross-linked rubber product is made from a rubber material that can be selected from the group consisting of polyisoprene rubber, styrene-butadiene rubber, silicone rubber, fluororubber, chloroprene rubber, ethylene-propylene diene rubber, natural rubber, and any combination thereof. The cross-linked rubber product can be selected from the group consisting of waste tires, waste shoes, waste rubber tubes, waste construction bearings, waste rubber gaskets, waste shock-resistant materials, waste water-swelling rubber, waste bumpers, etc.

The tensile fractured surfaces of the rubber particles arise from impinging the cross-linked rubber product by the high-speed jets fluid having the Reynold's number over 100,000. When the cross-linked rubber product is impinged, surfaces of the cross-linked rubber product are first fractured due to the impinging forces. Afterward, the high-speed jets fluid invades an interior of the cross-linked rubber product to laterally impinge C—S bonds of side chains and S—S bonds of cross-links, thereby shearing and eroding the cross-linked rubber product. Due to repeated actions of the high pressure jets fluid, the cross-linked rubber product is subjected to destructive forces, such as shearing, pulling, tearing, stretching and peeling forces and formed into a plurality of the rubber particles having the tensile fractured surfaces. Chemical reagents are not required to break the C—S bonds and the S—S bonds of the cross-linked rubber product. Consequently, the method of making the particulate rubber composition according to the present invention is not harmful to the environment, and is suitable for mass production at low costs. Furthermore, the rubber particles have very little or no coke clusters thereon, thereby enhancing applications of the rubber particles.

It is presumed that formation of the rubber particles of the particulate rubber composition from the cross-linked or vulcanized rubber product may be a mechanism as shown in FIG. 13. In FIG. 13, the cross-linked or vulcanized rubber product has S—S bonds and C—S bonds (C is present in main chains) as shown in an upper part of FIG. 13, and the rubber particles have no S—S bonds but include compounds having M—S bonds (M is transition metal) and C—Si bonds of silicon carbide as shown in a lower part of FIG. 13. The mechanism will be detailed hereinafter.

It is known that a molecular inner microstructure of a substance can be analyzed through Raman spectroscopy. In a Raman spectrum, a band at about 1332 cm⁻¹ signifies an amount of disorder in carbon materials and is called D-band, and a band at about 1580 cm⁻¹ represents graphite and is called G-band. A ratio of G-band to D-band (or a G/D value) is helpful for analyzing a composition and a structure of a substance. When a G/D value is greater than 1, a degree of carbonization is high such that electrons have a weaker tendency to move towards side-chain functional groups. This indicates that the crystal structure of graphite tends to be regular and the amount of disorder is reduced. When a G/D value is less than 1, electrons have a stronger tendency to move towards side-chain functional groups and tend to move in a radial direction, thereby resulting in a more side-band hybridized structure. In the present invention, the rubber particles of the particulate rubber composition have a G/D value that is measured by Raman spectroscopy and that ranges from 1 to 2. In an embodiment, the G/D value of the rubber particles ranges from 1.05 to 1.55.

According to the present invention, at least some of the rubber particles of the particulate rubber composition include a crystalline region. The crystalline region includes a crystalline structure of silicon carbide. Speculatively, silicon of silicon carbide comes from a filler, such as silicon oxide, added to the rubber material before vulcanization and bonded to carbon of the rubber particles to form silicon carbide which has a unit cell of a triclinic crystal system. The carbon combining with the silicon may come from the C—S bond that is cleaved due to the impinging action on the cross-linked rubber product.

The crystalline region also includes a crystalline structure of a compound containing a transition metal and sulfur. The transition metal is selected from the group consisting of zinc, titanium, manganese, iron, cobalt, nickel, and copper. Presumably, formation of this crystalline structure is due to the combining of sulfur with a transition metal to form a zinc blende structure. The sulfur resulted from cleavage of the C—S bond or the S—S bond upon impinging of the cross-linked rubber product, and the transition metal came from an accelerator added during cross-linking or an additive or a filler added before cross-linking. In an embodiment, the compound is zinc sulfide. The zinc atom of zinc sulfide may come from the accelerator, such as zinc oxide.

The rubber particles have a size that ranges from 0.019 mm to 1.5 mm. In an embodiment, the rubber particles have a size that ranges from 0.037 mm to 0.425 mm.

According to the present invention, the rubber particles of the particulate rubber composition may be incorporated into a polymeric matrix material. The polymeric matrix material may be polystyrene, or other rubbers. The particulate rubber composition may be added in an amount of over 20% based on a total weight of the matrix material plus the rubber particles, and the maximum amount may be up to 83 wt %. A large amount of the particulate rubber composition can be utilized for replacing a conventional raw rubber, a filler, or an additive (such as carbon black or silicon oxide), for production of products having enhanced impact resistance or other mechanical properties, for replacing a major material such as styrene-butadiene rubber, acrylonitrile-butadiene rubber, etc., for adding to asphalt products (e.g., emulsified asphalt and oily asphalt), and for mixing with water-proof coatings, sealants, etc. The particulate rubber composition may also be used in making the following products: (1) a tire or a reclaimed tire; (2) a shock-absorbing device for a bridge or a machine; (3) a rubber gasket, a water-blocking device, and a non-slid device; (4) an anti-glare rubber material for a dock; (5) a packing for a railroad; (6) a shoe making material; (7) a filler or an accelerator for rubber; (8) a rubber tube, a packaging material, and an elastic band; (9) a rubber pad, emulsified asphalt, modified asphalt, and other materials for road pavement; (10) a toy and a carpet; (11) an insulating material and a coating material; (12) modification of a plastic material such as polystyrene, acrylonitrile butadiene styrene, acrylic resin, epoxy resin, polyethylene, and polypropylene; (13) modifying a coating material so as to increase elasticity, anti-corrosion, weather resistance, and wear proof; (14) modifying a water-resistant material and a sealant so as to increase an anti-pollution capability, to reduce oil leakage and stickiness, and to lower a production cost; (15) a water-swellable rubber; (16) a shock-resistant material for an electronic device; (17) an outer case for an electronic device; (18) a photo resistor for an IC semiconductor, a printed circuit board, electronic packaging, a connector, and a dielectric film; (19) an optical disk, a liquid crystal display, a wide viewing film, a prism film, a backlight module, an organic light emitting diode, a polymer light emitting diode, an optical fiber, and a telecommunication device; (20) a biochip, a biomedical material, an artificial heart, medical equipments, and other biotechnology products. Preferably, the particulate rubber composition is used for producing shoe making materials and high impact-resistant polystyrene.

### EXAMPLES

### Production of Particulate Rubber Composition

The waste rubber product used for making the particulate rubber composition includes waste sheet segments of a tire that is manufactured by Japanese Dunlop Co. (Model No. SP350, 12R225, steel radial tubeless). The high-speed jets fluid device shown in FIG. 1 was developed and installed by the inventor of the present invention, and was operated to eject the high-speed jets fluid for impinging the waste sheet segments of the tire, which were placed in a container. The Reynold's number of the high-speed jets fluid was about 500,000, and the total output power for the jet fluid was about 61×10³ KJ. After several tens of seconds, the rubber particles of the particulate rubber composition were formed. The rubber particles were sieved and classified into three groups of particles, namely, Groups A, B, and C. The particle size distributions for Groups A, B, and C are shown in Table 1.

TABLE 1

| Example | Group | Particle size (mm) |
|---|---|---|
| 1 | A | 0.425-0.15 |
| 2 | B | 0.15-0.075 |
| 3 | C | 0.075-0.038 |

### Analysis of Particulate Rubber Composition

Examples 1-3 were analyzed and compared with comparative example 1 (rubber powder recycled from a waste tire through the conventional mechanical disintegration method and obtained from Yaw Shuenn Ind. Co., Ltd., 40 mesh, used as a filler for a shoe sole material, natural rubber), comparative example 2 (high quality natural rubber obtained from Song Day Enterprises Co. Ltd.), and comparative example 3 (vulcanized rubber sheet manufactured by Japanese Dunlop Co., Model No. SP350, 12R225, steel radial tubeless).

### 1. Analysis for Physical Appearance

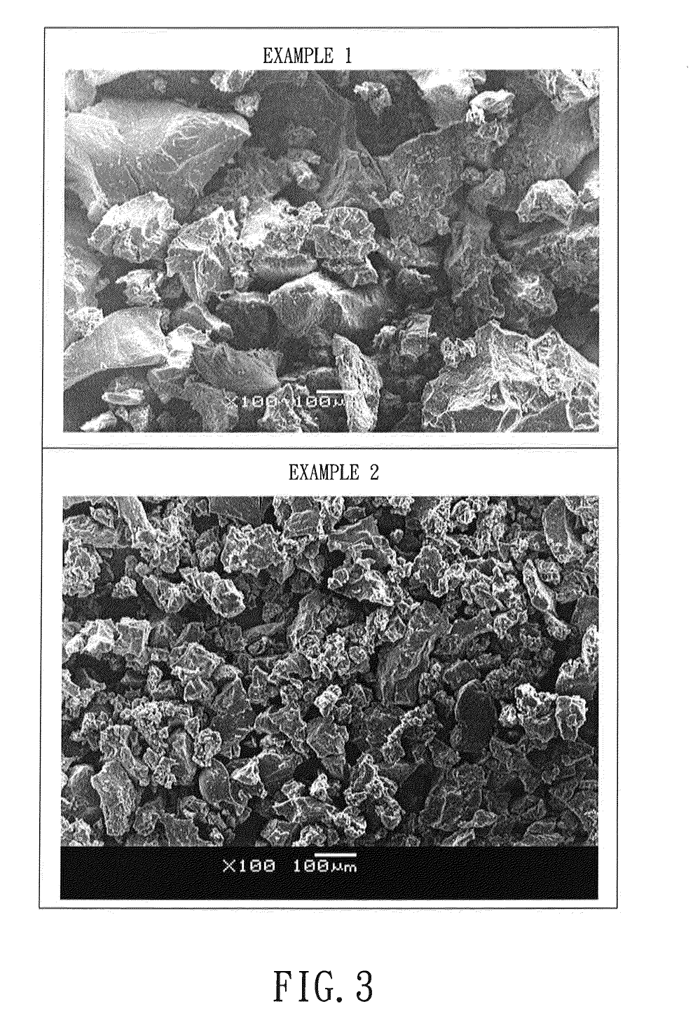

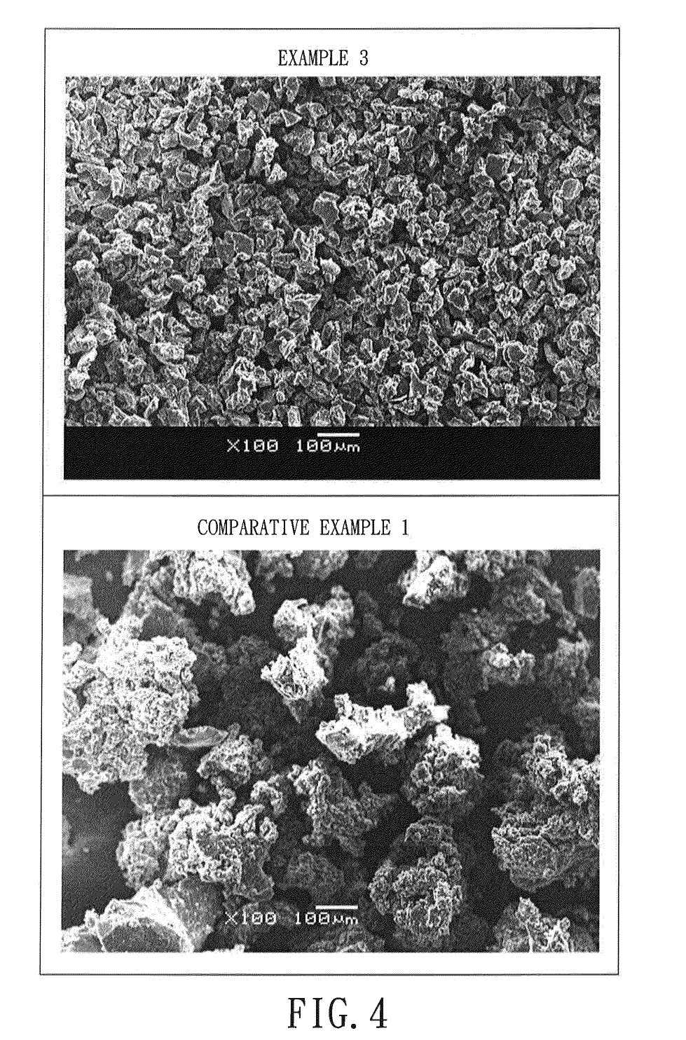

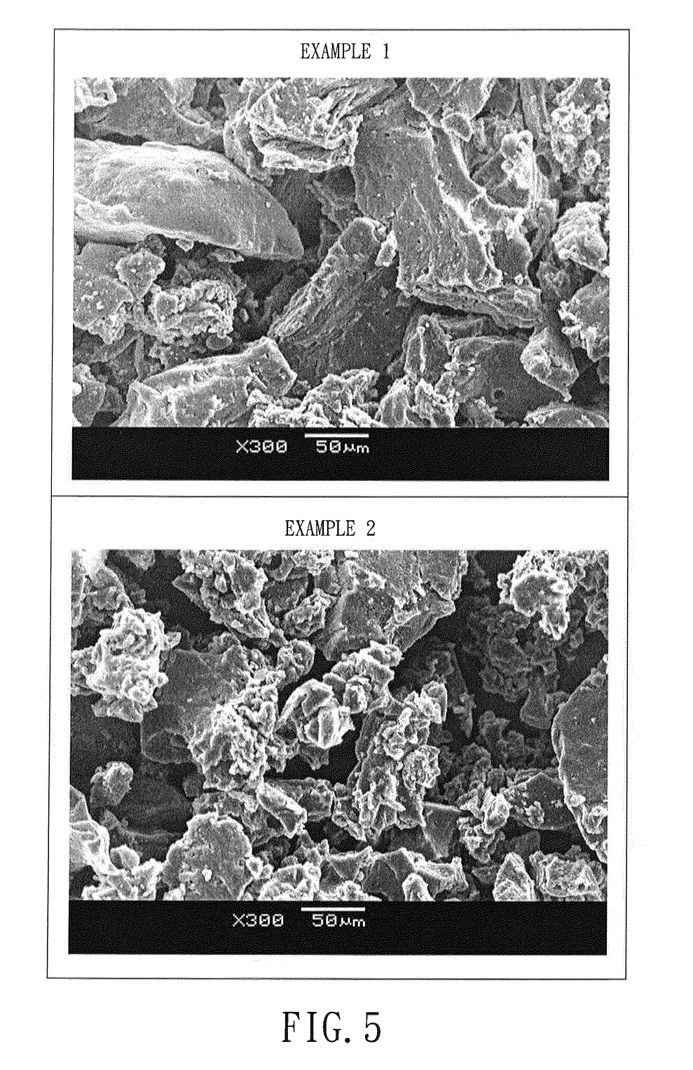

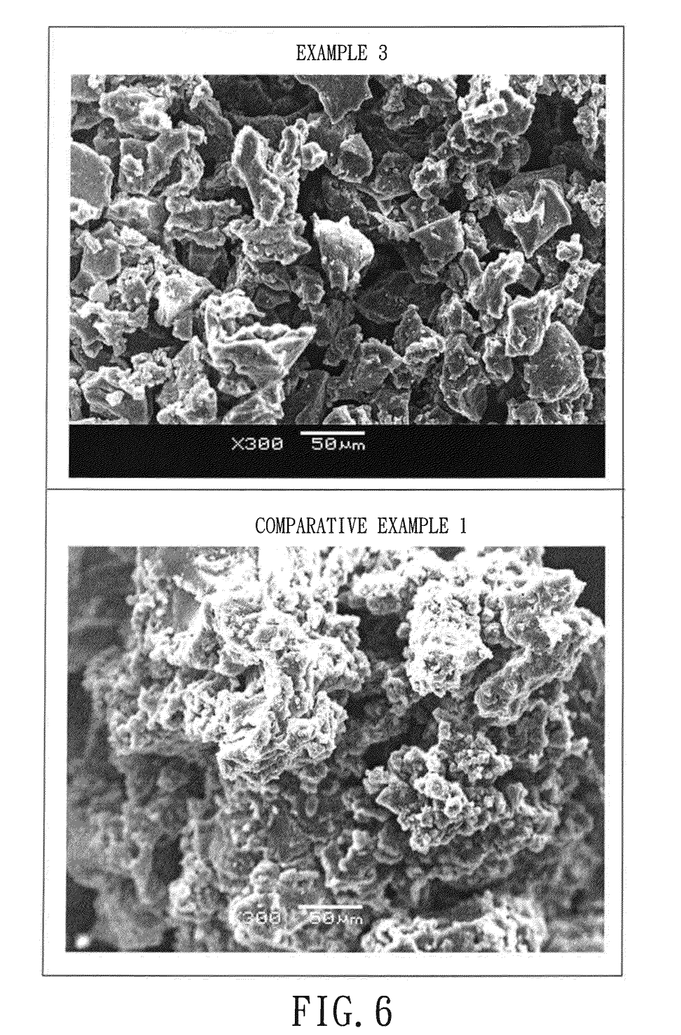

A scanning electron microscope (SEM) was used to analyze physical appearances of examples 1-3 and comparative example 1. The results are shown in FIGS. 3-6. FIGS. 3 and 4 are SEM microphotographs at 100× magnification. FIGS. 5 and 6 are SEM microphotographs at 300× magnification.

Referring to FIGS. 5 and 6, the surfaces of the particles of comparative example 1 have irregular coking clusters due to the destructive forces and the coking effect encountered in the conventional mechanical disintegration method. The coke clusters could lower a quality of the recycled rubber powder and limit the application of the same. On the contrary, the surfaces of the rubber particles of examples 1-3 do not have large amounts of coke clusters, but present tensile fractured surfaces that do not affect the application of the rubber particles. The different appearances of the examples and comparative example result from different recycling methods.

### 2. Analysis for Structure and Composition

### 2-1. Raman Spectroscopy

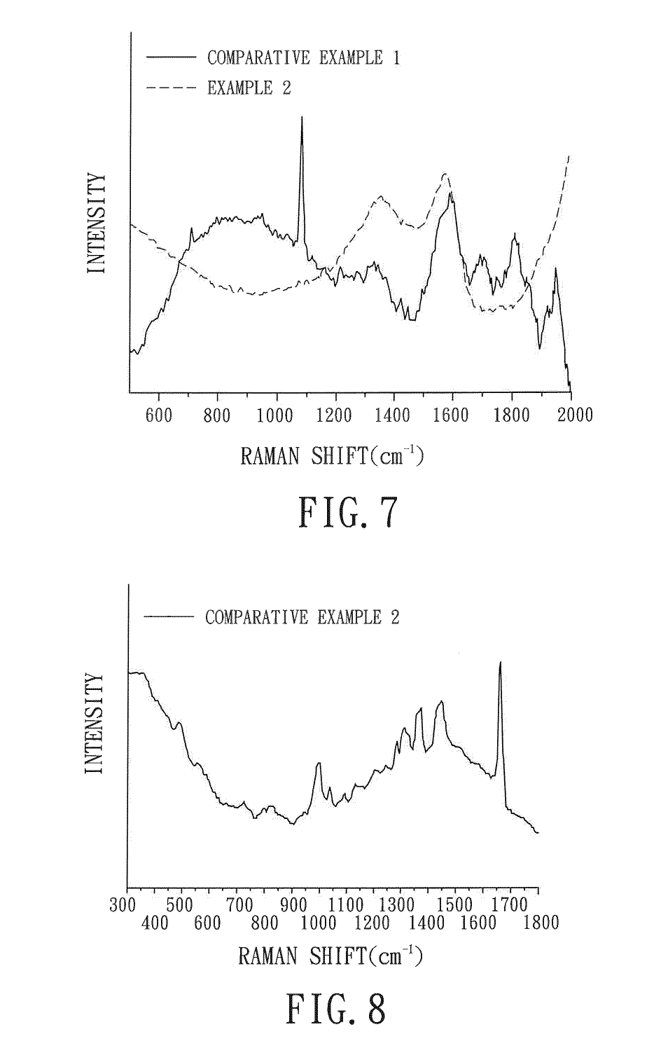

Examples 1-3 and comparative examples 1-3 were analyzed via a Raman spectrometer. FIG. 7 shows Raman spectra for comparative example 1 and example 2, and reveals that example 2 is different in molecular structure and composition from the recycled rubber powder of comparative example 1.

FIG. 8 shows a Raman spectrum for comparative example 2. Absorption bands of S—S bonds, D-band, and G-band do not appear on the Raman spectrum of the natural rubber.

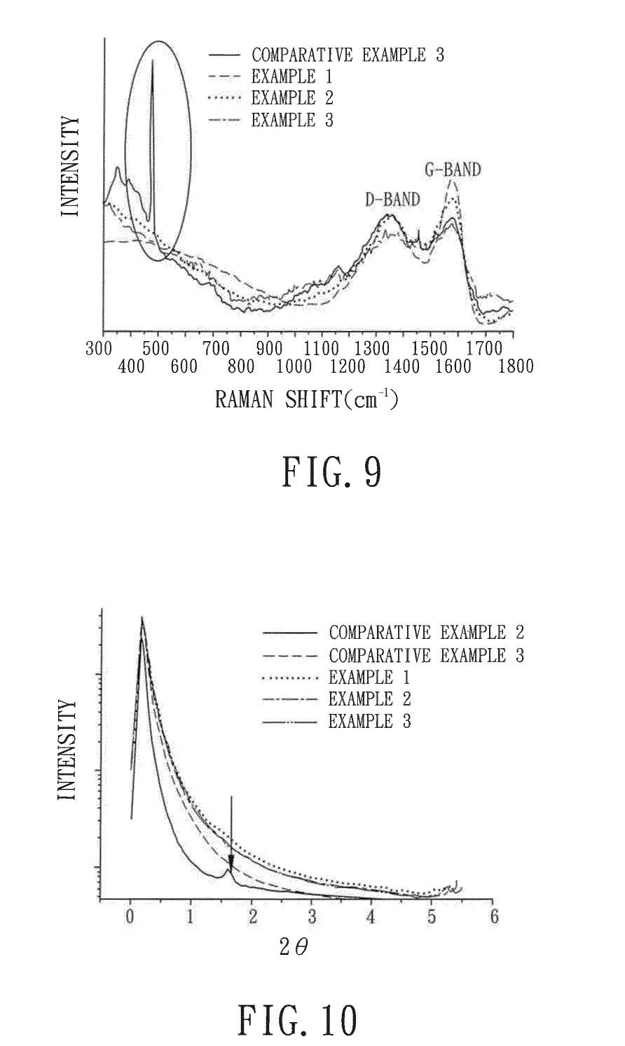

FIG. 9 shows Raman spectra for examples 1-3 and comparative example 3. An absorption band (at about 500 cm⁻¹) of S—S bonds is observed for the vulcanized rubber of comparative example 3. However, examples 1-3 have no such absorption bands of S—S bonds. Therefore, examples 1-3 are different in molecular structure and composition from the vulcanized rubber sheet of comparative example 3.

FIG. 9 further shows that D-band and G-band are present in the Raman spectrum for comparative example 3. G/D values for examples 1-3 and comparative example 3 are listed as follows: G/D of example 1 (1.22)>G/D of example 2(1.16)>G/D of example 3 (1.12)>G/D of comparative example 3 (0.77). Therefore, FIGS. 8 and 9 manifest that the molecular structures and compositions of examples 1-3 are different from those of the natural rubber of comparative example 2 and the vulcanized rubber sheet of comparative example 3.

It is noted that the G/D value of the rubber particles of examples 1-3 is proportional to the size of the same. More particularly, the bigger the size is, the greater the G/D value is. Therefore, the particle size and the level of carbonization of the rubber particles can be controlled by the method of the present invention.

### 2-2. Small Angle X-ray Scattering

Small angle X-ray scattering was used for analyzing examples 1-3, and comparative examples 2 and 3.

Referring to FIG. 10, the spectrum of comparative example 2 shows that the molecular structure of the natural rubber has an apparent long lattice spacing ordering and that the lattice spacing between chains is 4.65 nm (see the arrow in FIG. 10). Such a long lattice spacing ordering disappears in the spectrum of comparative example 3. This is because the lattice spacing between the main chains of the natural rubber no longer exists after vulcanization of the same. The spectra of examples 1-3 also have no long lattice spacing ordering. Hypothetically, carbonization occurs in the internal molecular structure of the rubber particles, and hence the molecules of the rubber particles undergo rearrangement. The results in FIG. 10 also manifest that the rubber particles of examples 1-3 are different from the natural rubber of comparative example 2.

### 2-3. Wide Angle X-ray Diffraction

Examples 1-3, and comparative examples 2 and 3 were analyzed by means of wide angle X-ray diffraction.

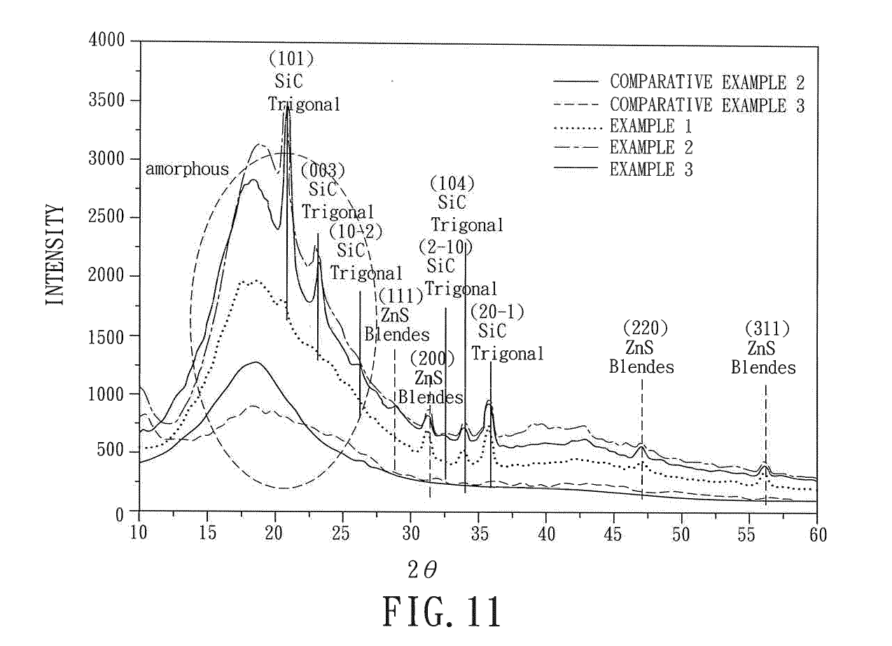

FIG. 11 shows the diffraction patterns for examples 1-3, and comparative examples 2 and 3. The circle in FIG. 11 shows that non-crystalline structure exists in all of the natural rubber of comparative example 2, the vulcanized rubber sheet of comparative example 3, and the rubber particles of examples 1-3. On the other hand, the diffraction patterns of examples 1-3 have diffraction peaks for silicon carbide having the triclinic crystal system, and for zinc sulfide having the zinc blende structure combined with other compounds MS (M is Zn, Ti, Mn, Fe, Co, Ni or Cu). The diffraction peaks of the zinc sulfide blendes appear at 111, 200, 220, and 311. No diffraction peaks of Zn—C bonds are present in the diffraction patterns of examples 1-3. This proves that the main chains of the rubber particles of examples 1-3 have no Zn—C bonds and that zinc combines with sulfur rather than carbon.

FIG. 11 further shows that the diffraction patterns of comparative examples 2 and 3 do not have diffraction peaks of silicon carbide and zinc sulfide. This indicates that examples 1-3 are different in composition and molecular structure from comparative examples 2 and 3.

FIG. 11 also shows that the diffraction peaks of silicon carbide appear on the diffraction patterns of examples 1-3 within a region where 2θ ranges from 20 to 30. The intensity of the diffraction peaks of silicon carbide decreases in the order of examples 1-3 listed as follows: example 3>example 2>example 1. Hence, the smaller the particle size of the rubber particles, the larger the amount of silicon carbide resulting from carbonization induced by the high-speed jets fluid.

### 2-4. X-ray Fluorescence Spectroscopy for Elemental Analysis

An X-ray fluorescence spectrometer was used to analyze the composition of the rubber particles of example 2. The results are shown in Table 2.

TABLE 2

| Element | Ppm | Element | ppm |
|---|---|---|---|
| Al | 124100 ± 6200 | Zn | >26340 ± 30 |
| Si | 154800 ± 1600 | Ge | 2.7 ± 1.4 |
| P | 6480 ± 150 | As | 12 ± 1.0 |
| S | >69520 ± 140 | Se | 1.3 ± 0.2 |
| Cl | 8396 ± 34 | Br | 13.9 ± 0.4 |
| K | 3536 ± 34 | Rb | 7 ± 0.3 |
| Ca | 17810 ± 90 | Sr | 20.3 ± 0.4 |
| Ti | 430 ± 9.9 | Y | 6 ± 0.4 |
| Mn | 39.1 ± 5.0 | Sb | 7.2 ± 1.6 |
| Fe | 2736 ± 16 | Cs | 15.3 ± 5.2 |
| Co | 181.4 ± 5.9 | Ba | 73 ± 14 |
| Ni | 34.4 ± 1.6 | La | 64 ± 16 |
| Cu | 86.4 ± 3.2 | Tl | 4.1 ± 0.7 |
| Pb | 47.2 ± 1.2 | | |

According to Table 2, example 2 not only includes Zn, Si, and S, but also has other transition metals such as Ti, Mn, Fe, Co, Ni, and Cu. Table 2 provides an evidence for the results of the wide angle X-ray diffraction analysis that the rubber particles have silicon carbide and the compounds (MS).

### 2-5. X-ray Absorption Spectroscopy

An X-ray absorption spectrometer was utilized to analyze examples 1-3, and comparative examples 2 and 3.

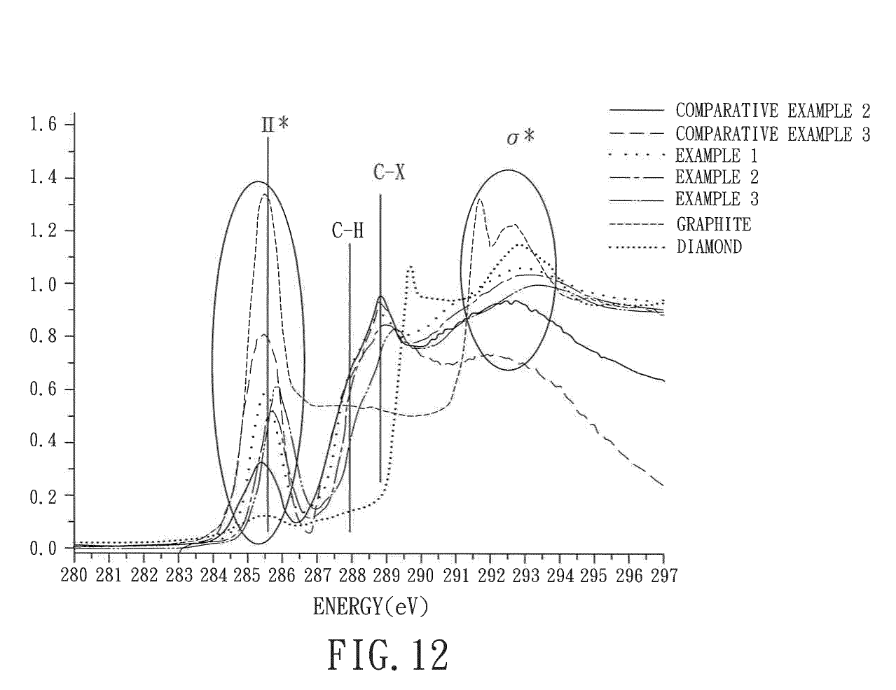

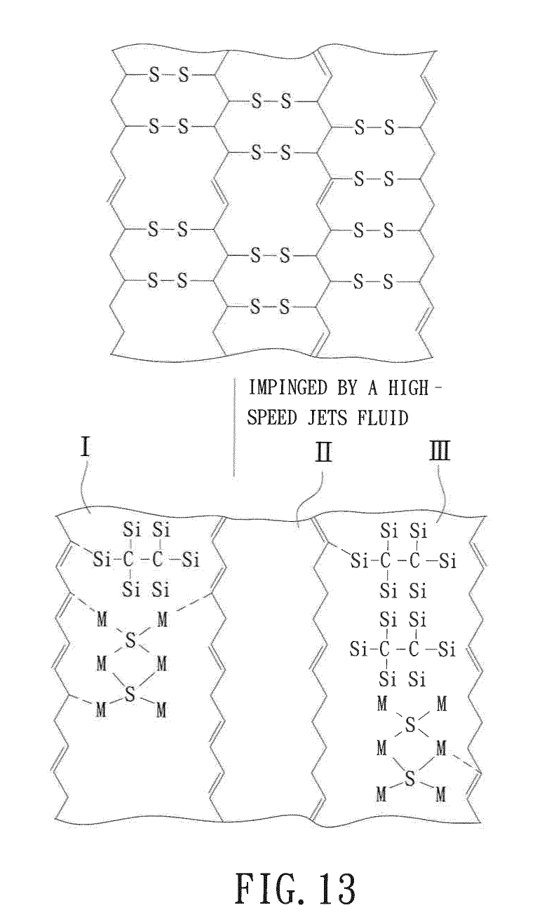

FIG. 12 shows spectra for examples 1-3, comparative examples 2 and 3, graphite, and diamond. Absorption bands of sp² hybrid orbitals (symbolized by π*), sp³ hybrid orbitals (symbolized by σ*), C—H bonds, and C—X bonds (X denotes nitrogen, silicon, sulfur, etc.) appear in the spectra. The spectrum of the natural rubber (comparative example 2) has a weak absorption peak of sp² compared to that of the vulcanized rubber sheet (comparative example 3). Speculatively, the C—S bonds of the vulcanized rubber sheet give rise to a stronger absorption peak of sp².

In contrast with the vulcanized rubber sheet, the rubber particles of examples 2 and 3 have absorption bands of sp² shifting to high energy level since fewer electrons are adjacent to carbon, and the electron affinity of carbon is smaller than that of silicon. Therefore, when the C—S bond is formed, because of the higher electron affinity of silicon, electrons of carbon tend to move towards silicon so that energy increases at the center of sp², thereby shifting the absorption peak to a high energy level.

According to the spectra of examples 1-3, the absorption peak of sp² for example 3 has the highest energy, whereas the absorption peak of sp² for example 1 has the lowest energy. This indicates that the smaller the particle size, the larger the amount of C—S bonds and the stronger the energy of the sp² absorption peak.

### 2-6. Quantitative Analysis for Polyisoprene

Polyisoprene content in each of examples 1-3 and comparative examples 2-3 was determined by means of ISO 5954-1989. The results are shown in Table 3.

TABLE 3

| | Exam- | | Exam- | Comparative | Comparative |
|---|---|---|---|---|---|
| | ple 1 | Example 2 | ple 3 | example 2 | example 3 |
| Polyisoprene | 31.08 | 33.03 | 31.18 | 59.16 | 6.50 |
| content | | | | | |
| (wt %) | | | | | |

According to Table 3, comparative example 2 includes the highest polyisoprene content (i.e., the largest numbers of double bonds). The polyisoprene content in comparative example 3 is reduced compared to that of comparative example 2, since double bonds of polyisoprene molecules are destroyed due to formation of cross-links (S—S bonds). Each of examples 1-3 has a polyisoprene content that increases considerably compared to comparative example 3. According to the results of the wide angle X-ray diffraction analysis, each of examples 1-3 also has the bond of the compound (MS). In FIG. 13, the transitional metals of the compounds (MS) are denoted by M that represents Zn, Ti, Mn, Fe, Co, Ni, or Cu. Each dotted line represents a weak force (e.g., Van der Waal's attraction) between a neutral atom or a molecule and a main chain. For example, an additive or a filler is dispersed around a molecular structure through such weak forces. After the S—S bonds are destroyed by the high-speed jets fluid, some S—S bonds are converted into M—S bonds (zinc blende, see the bottom of FIG. 13) or desulfurization occurs so that most of polyisoprene molecules having double bonds are restored and the numbers thereof are increased. The M-S compounds and silicon carbide are dispersed between the main chains of the rubber particles through the weak attraction forces. The weak attraction forces are present between carbon atoms of the main chains and the MS compounds, between the carbon atoms of the main chains and silicon carbide, and even between the MS compounds and silicon carbide. There are no covalent bonds between the MS compounds and the main chains, and between silicon carbide and the main chains (see zone I and zone III in FIG. 13). Referring to zone II in FIG. 13, none of the additive and the filler exists between the main chains in zone II (i.e., none of the crystalline structures are formed in zone II). The molecular structure shown in zone II is similar to that of the uncross-linked polyisoprene molecules (raw rubber).

The reason why not all of the double bonds of polyisoprene can be recovered in the rubber particles of the present invention is presumably that the main chains undergo rearrangement due to breakage of side-chain functional groups. This result is evident from the results of FIG. 13 in combination with that of FIG. 12 which shows that the energy levels of the absorption band of SP² (π*) for examples 1-3 are relatively high compared to comparative examples 2-3.

### Application of Particulate Rubber Composition

### Production of High-Impact Resistant Polystyrene Product

Synthetic rubber (acquired from Eternal Prowess Taiwan Co., Ltd., trade name: Chimei Q resin PB 5925, a blend of butadiene rubber and polystyrene) was mixed with the rubber particles of example 1, and a peroxide cross-linking agent according to the percentages of the components listed in Table 4. Mixing was carried out in a twin screw masticator at a controlled temperature of 150° C. for 3 minutes. The resulting mixture was put into a closed-type double roller banbury mixer, and was processed at 150° C. for 600 seconds by means of compression molding. Finally, products A, B, and C were formed.

TABLE 4

| | Product | | |
|---|---|---|---|
| Component | A | B | C |
| Synthetic rubber | 25% | 50% | 75% |
| Rubber Particles of | 75% | 50% | 25% |
| example 1 | | | |
| Peroxide | 0.5% | 0.5% | 0.5% |
| cross-linking agent | | | |

Products A, B, and C were tested for hardness and IZOD impact resistance. The hardness was measured according to ASTM D2240-05. The IZOD impact resistance was tested via ASTM D256-06a Method A. The results are shown in Table 5.

TABLE 5

| | Synthetic | Product | | |
|---|---|---|---|---|
| | rubber | A | B | C |
| Hardness | 40°~60° | 91° | 98° | 99° |
| (type D) | | | | |
| IZOD impact | 2.5 | 31 | 48 | 25 |
| resistance | | | | |
| (Kg-cm/cm) | | | | |

According to Table 5, the hardness of the products A, B, and C is greater than that of the synthetic rubber used to make products A, B, and C. This reveals that the rubber particles of example 1 can increase hardness of the synthetic rubber.

The synthetic rubber used for making products A, B, and C has an impact resistance (IZOD) of 2.5 Kg-cm/cm. The IZOD impact resistance of products A, B, and C increases to 25 Kg-cm/cm and even up to 48 Kg-cm/cm. Therefore, the rubber particles of example 1 can increase the impact resistance.

### Production of Rubber Sheet

17 g of natural rubber, 83 g of the rubber particles of example 1, 2 g of stearic acid, and 2 g of sulfur and an accelerator were mixed together in an open-type twin roller kneader at a temperature of about 25° C.-28° C., and were thereafter processed at 140° C. for 200 minutes through compression molding such that rubber sheet I was formed.

Rubber sheet II was made by following the aforesaid procedure for making rubber sheet I but replacing the rubber particle of example 1 with recycled rubber powder produced by the conventional mechanical disintegration method.

Rubber sheets I and II were tested for the following properties:
1. Tensile strength N/mm² (tested according to ASTM D412-06a);
2. Elongation % (tested according to ASTM D412-06a);
3. Hardness type A/1 SEC (tested according to ASTM D2240-05); and
4. Tear strength Kgf/cm (tested according to ASTM D624-00e1).

The results are shown in Table 6.

TABLE 6

| Properties | Rubber sheet I | Rubber Sheet II |
|---|---|---|
| Tensile strength | 123 | 69.0 |
| Elongation | 337 | 252 |
| Hardness | 58 | 52 |
| Tear strength | 32.3 | 20.9 |

The results of Table 6 show that the properties of rubber sheet I are better than those of rubber sheet II. Therefore, the rubber particles of example 1 could efficiently enhance mechanical properties such as tensile strength, elongation, hardness, and tear strength compared to the conventionally recycled rubber powder.

The results of Table 6 further show that good mechanical properties can be achieved even when example 1 is used in a large amount, i.e. up to 83% of a total weight of the composition to make rubber sheet I. This would indicate that the rubber particles of the present invention can be substituted for natural rubber, synthetic isoprene rubber, butadiene rubber, etc.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A particulate rubber composition comprising:
a plurality of rubber particles, at least some of said rubber particles having tensile fractured surfaces, said particulate rubber composition being produced by a method which comprises disintegrating a cross-linked rubber product to form said rubber particles using a high-speed jets fluid to impinge the cross-linked rubber product, the high-speed jets fluid having a Reynold's number that ranges from 100,000 to 4,000,000.

2. The particulate rubber composition as claimed in claim 1, wherein the high-speed jets fluid further has an initial velocity that ranges from 560 to 1150 m/sec.

3. The particulate rubber composition as claimed in claim 1, wherein the high-speed jets fluid further has initial kinetic energy ranging from 10×10³ to 995×10³ KJ based on a single nozzle.

4. The particulate rubber composition as claimed in claim 1, wherein a temperature of an impinged area of the cross-linked rubber product ranges from 40° C. to 95° C.

5. The particulate rubber composition as claimed in claim 1, wherein said rubber particles have a G/D value that is measured by Raman spectroscopy and that ranges from 1 to 2.

6. The particulate rubber composition as claimed in claim 5, wherein the G/D value of said rubber particles ranges from 1.05 to 1.55.

7. The particulate rubber composition as claimed in claim 1, wherein at least some of said rubber particles have a crystalline region.

8. The particulate rubber composition as claimed in claim 7, wherein said crystalline region includes silicon carbide.

9. The particulate rubber composition as claimed in claim 7, wherein said crystalline region includes a compound containing a transition metal and sulfur.

10. The particulate rubber composition as claimed in claim 9, wherein said crystalline region has a zinc blende structure.

11. The particulate rubber composition as claimed in claim 9, wherein said transition metal is selected from the group consisting of zinc, titanium, manganese, iron, cobalt, nickel, and copper.

12. The particulate rubber composition as claimed in claim 9, wherein said crystalline region includes zinc sulfide.

13. The particulate rubber composition as claimed in claim 1, wherein said rubber particles have a size that ranges from 0.019 mm to 1.5 mm.

14. A product comprises:
a polymeric matrix material; and
a particulate rubber composition as claimed in claim 1, which includes a plurality of rubber particles incorporated into said polymeric matrix material.

15. The product as claimed in claim 14, wherein said polymeric matrix material is polystyrene.
